(19) United States
(12) Patent Application Publication
(10) Pub. No.: US 2015/0000342 A1
(43) Pub. Date: Jan. 1, 2015

(54) PROCESS AND DEVICE FOR PURIFYING SILICON

(71) Applicant: COMMISSARIAT A L'ENERGIE ATOMIQUE ET AUX ENERGIES ALTERNATIVES, Paris (FR)

(72) Inventors: Olivier Bonino, Jacob-Bellecombette (FR); David Pelletier, Chambéry (FR)

(73) Assignee: COMMISSARIAT A L'ENERGIE ATOMIQUE ET AUX ENERGIES ALTERNATIVES, Paris (FR)

(21) Appl. No.: 14/369,052

(22) PCT Filed: Dec. 21, 2012
(86) PCT No.: PCT/EP2012/076619

§ 371 Date: Jun. 26, 2014

(30) Foreign Application Priority Data
Dec. 27, 2011 (FR) 1162469

(51) Int. Cl. C01B 33/037; B01D 1/22

(52) U.S. Cl. CPC C01B 33/037; B01D 1/221; B01D 1/222
USPC 65/134.2; 65/347; 65/178

(57) ABSTRACT

Device (20) for purifying a molten material such as silicon, comprising a chamber (21) comprising a crucible (2; 15) for storing a molten material and a heating device (4) for heating the molten material contained in the crucible, the chamber being equipped with a device (22) for greatly lowering the pressure in the chamber, characterized in that it comprises at least one evaporator (10; 10, 10′) placed inside the chamber to receive part of the molten material, such that this molten material has a large interface with low-pressure vapour present in the chamber (21) to promote and accelerate the purification of the molten material.

The invention relates to a process and a device for purifying silicon.

The manufacture of photovoltaic or electronic devices requires the use of very pure silicon. Metallurgical silicon comprises too many impurities for such applications, and especially an excessively high concentration of phosphorus, boron and certain metal elements such as iron, aluminium, copper, titanium, etc.

This is why silicon purification processes were performed in the prior art.

A first existing process consists of a purification via a gaseous route. This process has the drawback of being very expensive.

Document WO 2010/126 067 describes a silicon purification process which comprises a step of phosphorus purification by irradiation with an electron gun. This process also has the drawback of being very expensive.

Document WO 2011/033 188 describes another silicon purification process which consists in applying a thermal gradient to molten silicon in an environment at reduced pressure.

The latter solution has the drawback of requiring, for the phosphorus purification of silicon, very long treatment times.

Document U.S. Pat. No. 6,036,932 describes a device for purifying silicon in which the silicon to be purified is placed at the top of the device, heated and then transported by capillary action along a fibre. The pressure inside the device is lowered and the silicon is thus purified during its transportation in and/or on the fibre. Finally, the purified silicon is emptied into a recovery tank at the bottom of the device. Simple transportation by capillary action along a fibre does not make it possible to achieve high purification.

Document WO 2008/064 738 similarly describes a device for purifying silicon for the purpose of application for a photovoltaic device. The purification device comprises an upstream device which prepares the silicon, which is melted in a crucible and then conveyed into a low-pressure chamber via a channel. In this low-pressure chamber, the silicon undergoes purification by evaporation. Finally, the silicon is cooled and recovered at the bottom of the chamber. This solution similarly remains insufficient to achieve satisfactory purification.

Thus, the object of the invention is to propose a solution for the purification of silicon, which is efficient and inexpensive, and compatible with application in the photovoltaic field.

To this end, the invention is based on a device for purifying a molten material such as silicon, comprising a chamber comprising a crucible for storing a molten material and a heating device for heating the molten material contained in the crucible, the chamber being equipped with a device for greatly lowering the pressure in the chamber, characterized in that it comprises at least one evaporator placed inside the chamber to receive part of the molten material, such that this molten material has a large interface with low-pressure vapour present in the chamber to promote and accelerate the purification of the molten material, and in that it comprises at least one device for renewing the molten material in the at least one evaporator.

The device for purifying a molten material such as silicon may comprise at least one heating device for heating the molten material contained in the at least one evaporator.

The purification device may comprise a fixed pouring crucible positioned above at least one fixed evaporator allowing the flow of the molten material, purifying it up to a recovery tank.

The purification device may comprise at least one mobile component allowing several circulations of the molten material in the at least one evaporator.

Thus, the device for renewing the molten material in the at least one evaporator may allow the partial or total renewal or circulation of the molten material in the at least one evaporator. This molten material may thus reside or pass through the same evaporator several times during the same purification cycle, to finally increase its total purification.

The purification device may comprise at least one crucible in the lower part of the chamber, and at least one evaporator that is mobile between a top position outside the crucible and a bottom position in which it is at least partially placed in the crucible.

The purification device may comprise at least one pouring crucible that is mobile between a top position outside the crucible in which it is capable of versing molten material onto an evaporator and a bottom position in which it is at least partially placed in the crucible.

The purification device may comprise a mobile evaporator or a mobile pouring crucible and may comprise an axle passing through the chamber via a leaktight aperture and a motor outside the chamber acting on the axle to actuate the mobile evaporator or the mobile pouring crucible.

The heating device for heating the molten material contained in the crucible and/or a heating device for heating the molten material contained in the at least one evaporator may be of resistive or inductive type, or inductive with an induction frequency of between 50 Hz and 300 MHz inclusive.

The purification device may comprise a device for stirring the molten material present in the crucible.

The purification device may comprise at least one evaporator comprising several at least partially superposed horizontal or inclined plates.

The invention also relates to a process for purifying a molten material such as silicon placed in a purification device as described above, comprising a step of heating and melting the molten material present in a crucible of the purification device and of lowering the pressure in the chamber of the purification device, characterized in that it comprises a step of moving at least part of the molten material from the crucible to an evaporator.

The temperature of the molten material may be maintained above or equal to 1500° C. and the pressure in the purification device chamber may be lowered to a value of less than or equal to 1 pascal.

The process for purifying a molten material such as silicon may comprise a step of purifying molten material, especially its dephosphoration, comprising a repetition of moving and then renewing an amount of molten material on at least one evaporator from the molten material present in the crucible of the purification device.

The purification step may comprise a step of total or partial renewal of the molten material present on at least one evaporator by immersing this at least one evaporator in the crucible of the purification device or by immersing at least one pouring crucible into the crucible of the purification device and then gradually pouring its content onto at least one evaporator.

The step of purifying the molten material may comprise a step of evaporating the impurities from the molten material present on the evaporator.

The rate of immersion and of withdrawal of the evaporator or of the pouring crucible may be between 0.5 mm/s and 10 cm/s, or between 1 mm/s and 1 cm/s.

The process for purifying a molten material such as silicon may comprise a step of heating the molten material present on the evaporator outside the crucible.

These subjects, characteristics and advantages of the present invention will be presented in detail in the following description of particular embodiments given in a non-limiting manner in relation to the attached figures, among which:

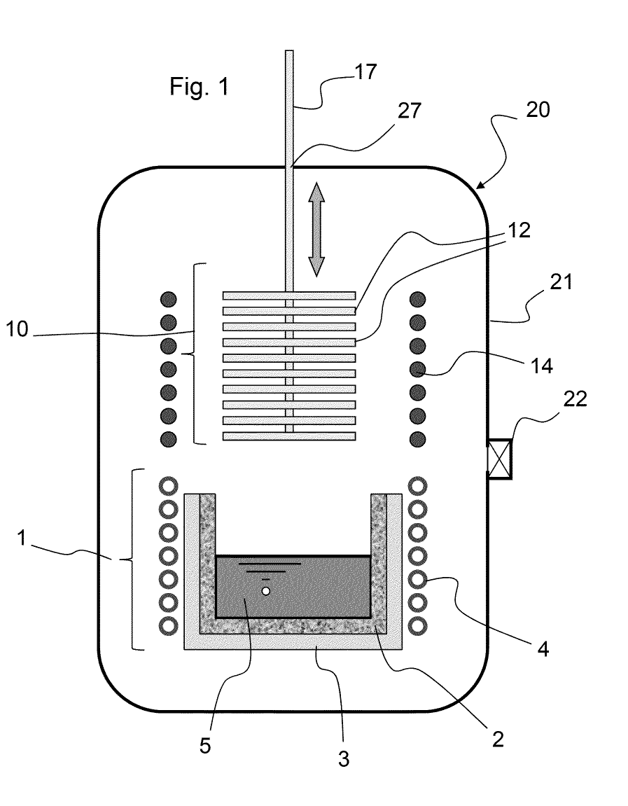

FIG. 1 schematically represents a silicon purification device according to a first embodiment of the invention.

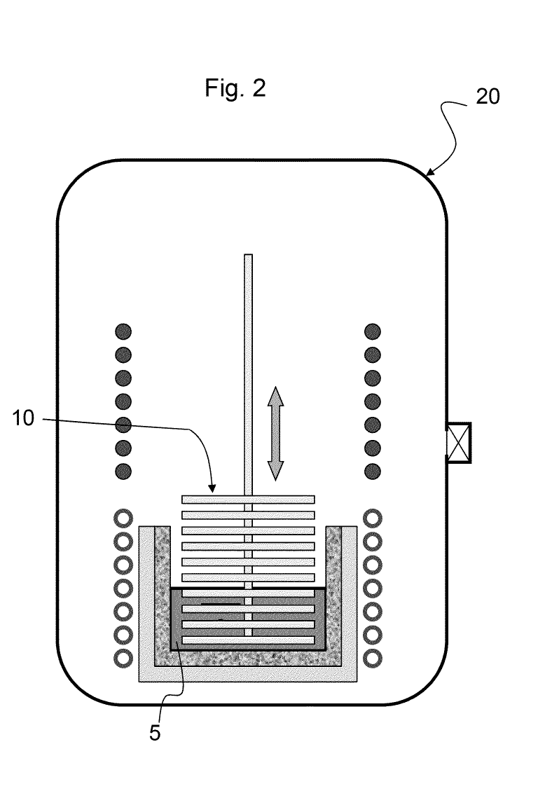

FIG. 2 schematically represents the silicon purification device in a second configuration according to the first embodiment of the invention.

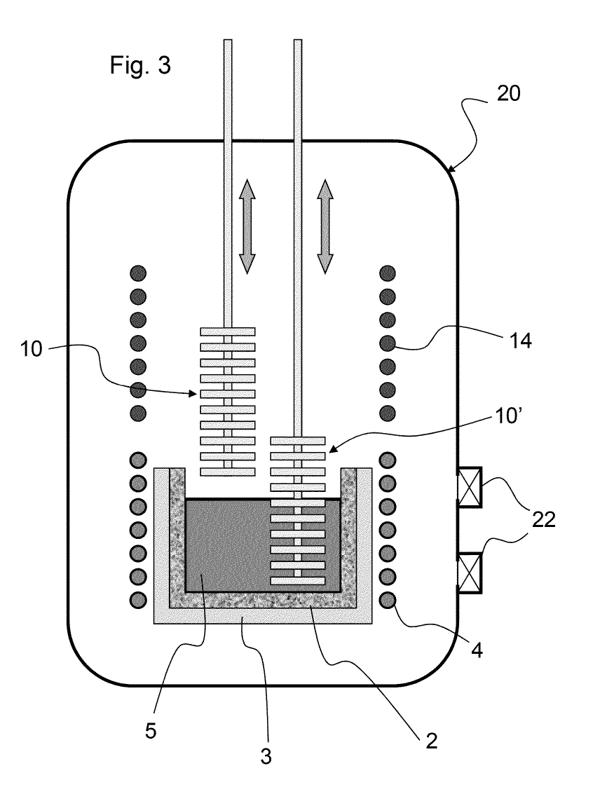

FIG. 3 schematically represents a silicon purification device according to a second embodiment of the invention.

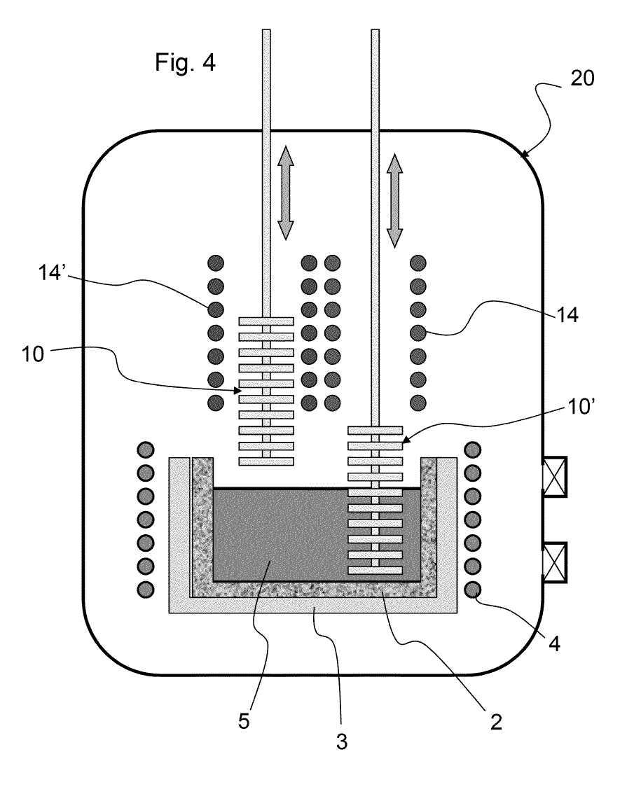

FIG. 4 schematically represents a silicon purification device according to a variant of the second embodiment of the invention.

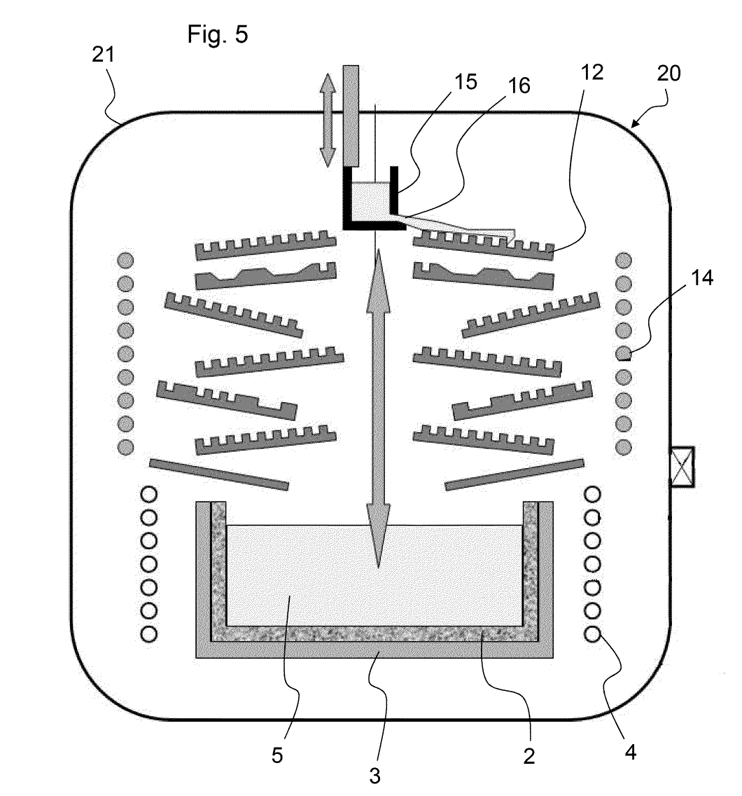

FIG. 5 schematically represents a silicon purification device according to a third embodiment of the invention.

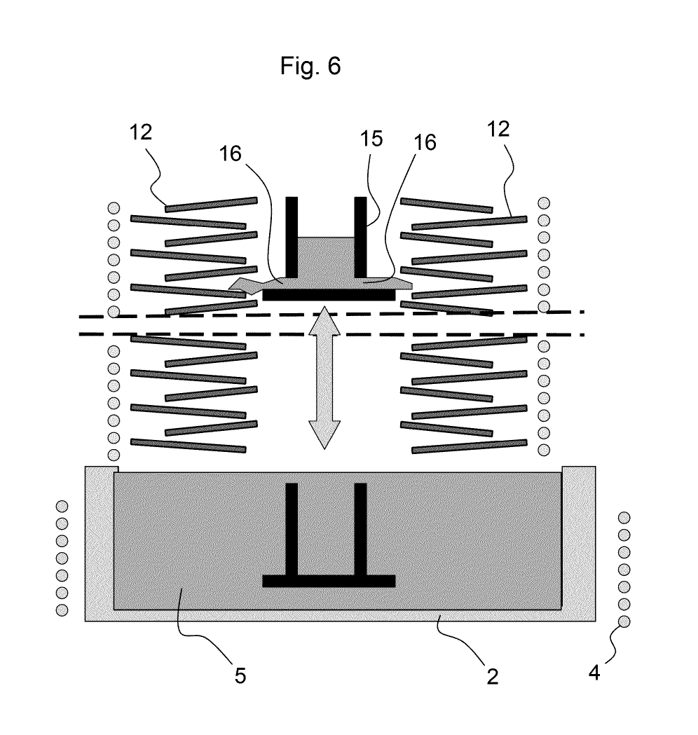

FIG. 6 schematically represents a silicon purification device according to a first variant of the third embodiment of the invention.

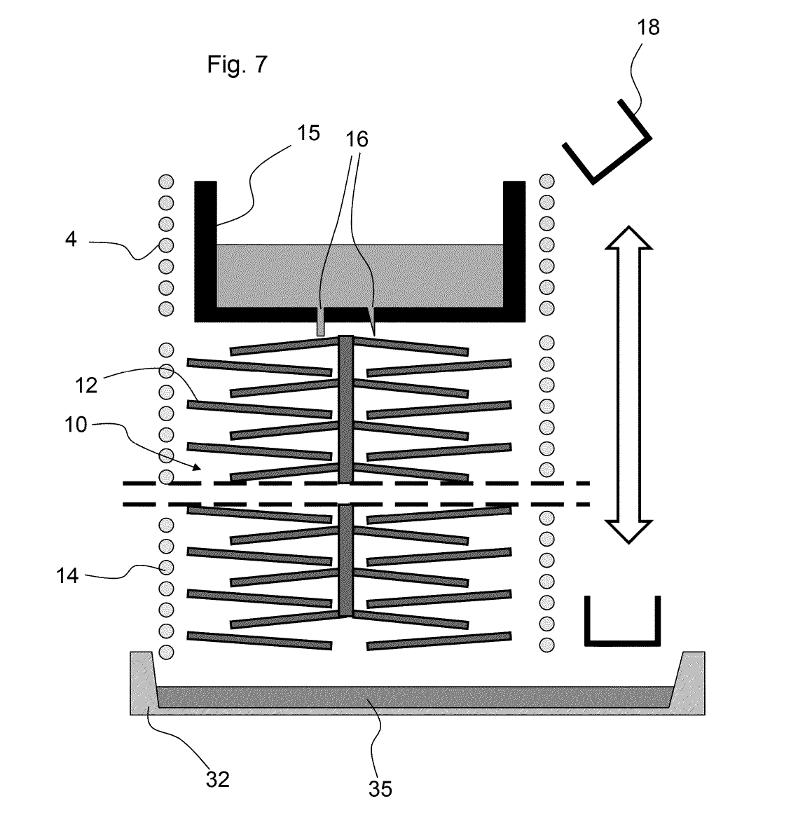

FIG. 7 schematically represents a silicon purification device according to another variant of the third embodiment of the invention.

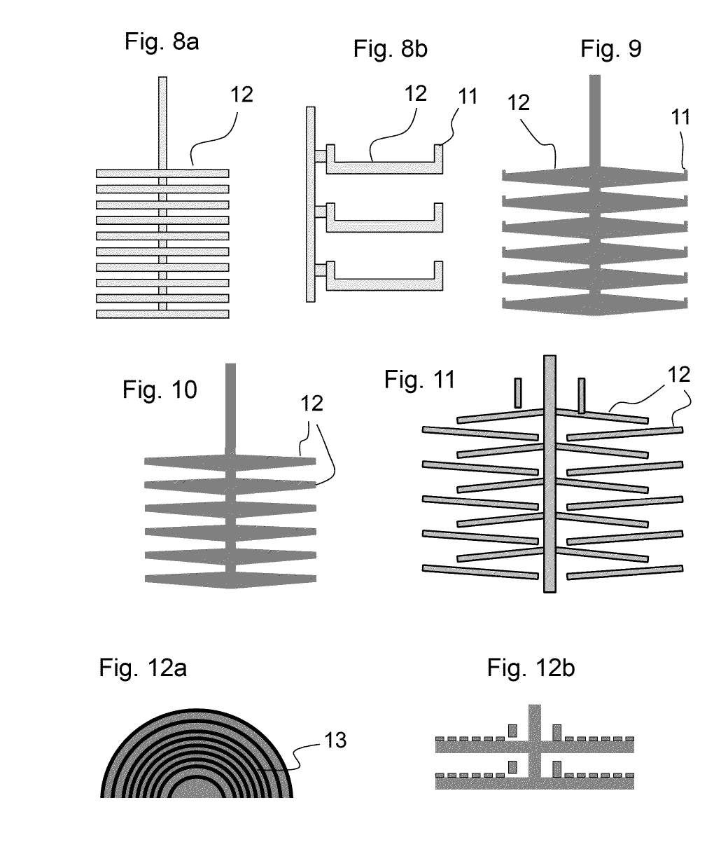

FIGS. 8 to 11 schematically represent various evaporators that are compatible with a purification device according to the invention.

FIGS. 12a to 12b schematically represent, respectively, in top view and in side cross section, another evaporator compatible with a purification device according to the invention.

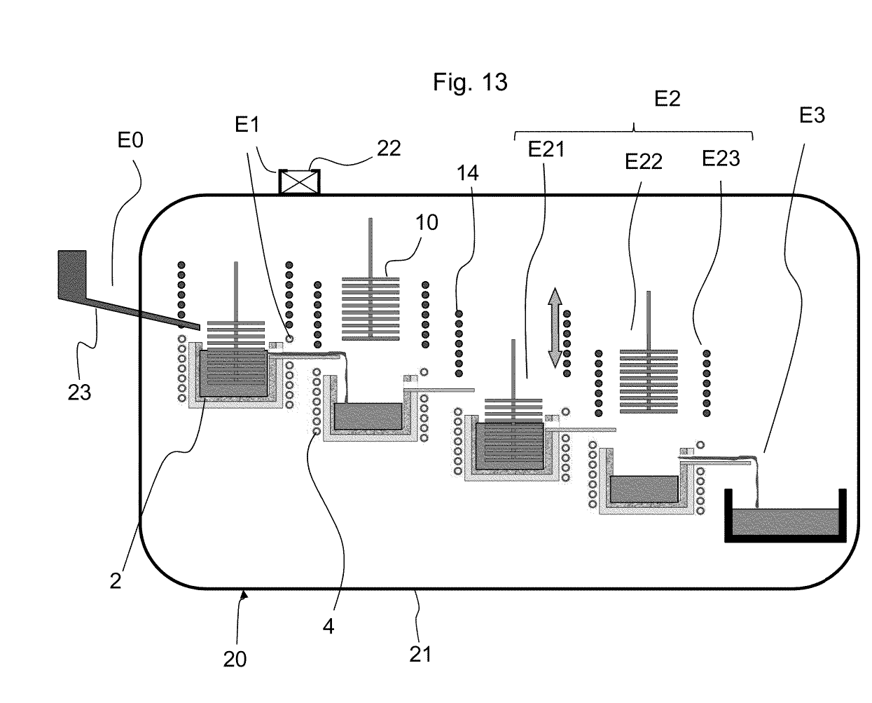

FIG. 13 schematically represents the implementation of a silicon purification process according to one embodiment of the invention.

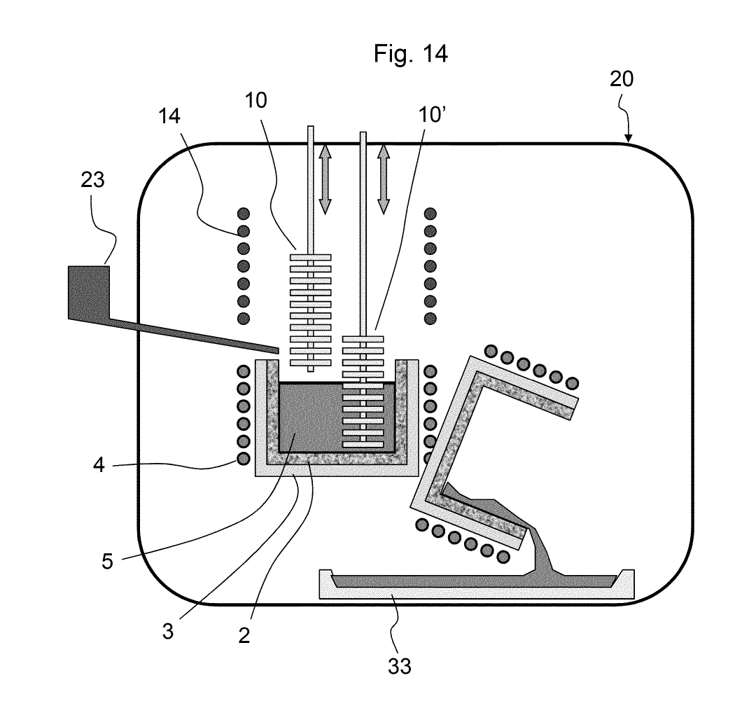

FIG. 14 similarly schematically represents the implementation of the silicon purification process according to one embodiment of the invention.

To facilitate the understanding of the description that follows, the same references will be used for similar or equivalent elements in the various embodiments and variants.

FIGS. 1 and 2 thus illustrate a silicon purification device 20 according to a first embodiment. This silicon purification device 20 comprises a bottom part 1 intended to receive a bath of molten silicon, and an “evaporator” top part 10 intended to receive part of the molten silicon to promote the evaporation of the impurities to be removed, such as phosphorus, so as to purify the silicon. These two top and bottom parts are arranged in the same leaktight chamber 21 comprising a device 22 for evacuating the interior of the chamber 21, which makes it possible to continuously lower the pressure in the chamber (vacuum or pumping group).

The bottom part 1 of the silicon purification device comprises a crucible 2 forming a receiving tank for a bath 5 of silicon. This crucible 2 may optionally be arranged in a counter-crucible 3 and/or an insulator. The crucible may be made, for example, of graphite or of any other material that is suitable for containing molten silicon. The crucible 2 is furthermore combined with a heating device 4, which is suitable for raising the temperature of the silicon 5 placed in the crucible 2 above 1500° C. By way of example, a 28 kg charge of silicon metal may thus be contained in a graphite crucible of cylindrical geometry with an internal radius of 15 cm and 25 cm tall, surrounded on the sides and on the base with an insulator of about 1 cm made of graphite felt. The heating device 4 of the crucible 2 comprises, for example, an induction coil which surrounds the crucible and optionally insulates it, of cylindrical geometry (helical), and contained in the vacuum chamber 21 of the device. The chosen induction frequency is 420 Hz, but may as a variant be between 50 and 100 000 Hz inclusive and preferably between 50 and 1000 Hz. As a comment, the induction heating device furthermore makes it possible to create stirring of the silicon bath 5 favourable to its dephosphoration under vacuum. A specific stirring system may nevertheless be provided in place or in addition.

The function of the evaporator 10 is to evaporate the silicon impurities, such as phosphorus, to separate them from the silicon. To do this, it is characterized in that it creates a large interface between the liquid silicon to be purified and the vapour at very low pressure of the chamber 21, so as to optimize the amount of phosphorus which escapes from the silicon due to the difference in vapour pressure between phosphorus and silicon. Similarly, other elements are also separated from the silicon in the evaporator. In this way, this evaporator fulfils the function of evaporating certain impurities contained in the silicon, at a rate and in a yield significantly higher than those of an evaporation phenomenon which may take place at the surface of the simple silicon bath 5 such as that contained in the crucible 2 since the silicon liquid/vapour interface is greater and the temperature in the evaporator may be higher.

In this embodiment, the evaporator 10 is mobile in vertical translation relative to the crucible 2, so as to be able to descend into the silicon bath 5 contained in the crucible 2 in its bottom position, illustrated by FIG. 2. Next, the evaporator rises outside the crucible 2, filled with molten silicon, to its top position illustrated by FIG. 1. In the bottom position, the bottom of the evaporator may be located just above the base of the crucible, and in the top position, the bottom of the evaporator may be about 15 cm above the crucible. The evaporator 10 is mobile via a motorized device placed outside the chamber 21, not shown, which makes it possible to generate the vertical translation movements of the evaporator via an axle 17 integrally attached to the evaporator 10 and passing through a leaktight aperture 27 of the chamber 21.

This movement of the evaporator 10 makes it possible to fill or to cover with molten silicon its horizontal plates 12, more particularly represented by FIGS. 8a and 8b, which form large-area reservoirs. According to one embodiment, the evaporator comprises a stack of plates 12 superposed every 2 cm and connected via an axle 17, each plate having a disc shape with a radius of 10 cm and a thickness of 1 cm. The plates are horizontal, ending at their edge with a riser of about a millimetre, thus forming a reservoir that can contain liquid silicon.

The evaporator 10 is furthermore advantageously combined with a heating device 14, arranged in the top part of the chamber 2, so as to allow heating of the silicon present on the evaporator when this evaporator is outside the crucible 2 in its top position, and thus to promote the evaporation phenomenon explained previously. This heating device 14 may furthermore be made with an induction coil, contained in the top part of the chamber, of cylindrical geometry (helical), so as to surround the evaporator when it is located in the top position. The induction frequency is 10 kHz, and may as a variant be between 2 kHz and 300 MHz inclusive. As for the crucible 2, the evaporator may be made, for example, of graphite.

As a variant, the two heating devices 4, 14 of the bottom and top parts of the silicon purification device may take any form other than that described above. In particular, they may be of resistive type, or inductive type with induction frequencies other than those mentioned. Furthermore, in the case of heating by induction, the heating device 4, 14 may be outside or inside the chamber to be heated. According to an embodiment variant, it is advantageous to provide a heat-insulated induction coil of the evaporator to minimize the heat losses by radiation. To do this, it may be envisaged to place a graphite felt between the coils and the evaporator. The induction heating device 14 of the evaporator 10 may be coupled to a susceptor to transmit the heat. It may be made directly in the body of the evaporator. The two mentioned heating devices 4, 14 may be different or, as a variant, may belong to the same heating device, which may as an option offer different heating powers in the two top and bottom zones of the chamber 21.

The chamber 21 may furthermore be equipped with at least one additional inlet and outlet, which may or may not be different, not shown in FIGS. 1 and 2, for automated feeding of liquid silicon to be purified, on the one hand, and recovery of the purified silicon, on the other hand. For this, it may, for example, be equipped with an inlet-outlet lock. As a variant, an introduction of the silicon to be purified in solid form may be envisaged. It may also be envisaged to open the chamber in order to load in the silicon, to close it in order then to perform the purification and finally to open it again to recover the purified silicon.

Advantageously, a collector made of graphite (not shown) may also be provided in the chamber to recover the silicon vapour, evaporated during the purification, in the form of condensates. This collector may be placed between the coil/the heat insulator and the evaporator and also above the evaporator. Its form may be optimized to recover at the bottom the silicon which flows into a recovery vessel.

FIGS. 3 and 4 illustrate a second embodiment of the invention, in which the silicon purification device 20 differs from the preceding embodiment in that it comprises two evaporators 10, 10′ that are translationally mobile in the same chamber 21, capable of descending within the same crucible 2 or of being located above and outside this crucible 2. The two embodiments of these two figures represent two embodiment variants. In the first embodiment of FIG. 3, a single heating device 14 is provided at the top of the chamber 21, which heats the two evaporators 10, 10′, when they are in the top position. In the variant of FIG. 4, two different heating devices 14, 14′ are provided at the top of the chamber 21, to heat, respectively, each of the two evaporators 10, 10′ independently. As a variant, any other number of evaporators, greater than 2, may also be envisaged in the chamber 21. As a comment, the movements of the two evaporators may be coordinated (in phase or out of phase, for example) or completely independent.

In the embodiments described above, the feeding and renewal of the silicon on the evaporator(s) is thus obtained by the mobility of this or these evaporator(s), especially by their possibility of immersion into the crucible.

FIGS. 5 and 6 illustrate a third embodiment of the invention, in which the purification device 20 comprises a pouring crucible 15, which is mobile in vertical translation between a top position, in which it can verse silicon onto the evaporator 10, which is fixed in this embodiment, and a bottom position in the crucible 2 so as to fill its storage volume with molten silicon. In the illustrated example, the crucible has one or more orifices in its bottom part through which the liquid silicon can flow. The flow on the evaporator may thus take place not only in the top position but also during the movement of the pouring crucible. As a variant, the pouring crucible may not have an orifice: it may then be combined with a tipping mechanism to allow the flow of the silicon from the top of the pouring crucible. As a variant, not shown, several pouring crucibles 15 may be cumulated.

The purification device represented in FIG. 6 differs very slightly from the embodiment illustrated in FIG. 5 by the shape of the pouring spout and the shape of the evaporator.

The embodiment variant illustrated by FIG. 7 comprises a fixed pouring crucible 15 of larger size, similar to the crucible 2 of the preceding embodiments. It gradually verses molten silicon onto the evaporator 10, which leads it slowly to a simple recovery tank 32 positioned at the bottom, and which stores the silicon 35. A component 18 is mobile between a bottom position in which it can recover molten silicon in the recovery tank 32 and a top position in which it can pour its contents into the pouring crucible 15. This mobile component 18 may advantageously be in the form of a crucible equipped with a heating means for keeping the silicon liquid. It thus makes it possible to perform uninterrupted circulation of molten silicon on the evaporator 10.

As has been seen previously, the solution adopted uses at least one evaporator, different from the crucible 2 or from the pouring crucible 15 for storing a bath of silicon, which generates a large interface between the liquid silicon and the low-pressure vapour of the chamber 21, to obtain an efficient evaporation effect of the impurities. This approach makes it possible to greatly increase the rate of dephosphoration relative to a single bath of liquid silicon contained in a crucible.

Moreover, the device comprises a mobile component which allows the recirculation or renewal of molten silicon on the evaporator. Such a solution makes it possible to minimize the bulk of the evaporator and of its active surface since it is possible to obtain the desired result, in terms of purification of silicon, by setting the iterations (recirculations or renewal) of the silicon on an evaporator as many times as is necessary. The silicon can thus undergo several passages through the same evaporator during a purification cycle. For a constant evaporator surface area, it is possible to obtain a degree of purity that is modulable for the silicon, and especially the desired phosphorus content, simply by modifying the treatment time and thus indirectly the number of recirculations of the molten silicon on the evaporator. This approach thus makes it possible to obtain very substantial purification with a device of low bulk.

The evaporator may take various forms.

FIGS. 8 to 12a-12b illustrate schematically, to this end, several possible embodiments of an evaporator. Each of them may be used in all the embodiments of the purification device 20 described previously.

FIG. 8a represents the evaporator used in the embodiments described previously with reference to FIGS. 1 to 4, which comprises superposed horizontal plates 12 forming silicon storage reservoirs. FIG. 8b shows a cross section of a few of the horizontal plates 12 forming reservoirs, delimited by rims 11. FIG. 9 represents a variant in which the plates 12 are inclined, and in which their end comprises a rim 11. In the variant of FIG. 10, these rims 11 are eliminated. FIG. 11 represents another variant comprising an alternance of plates 12 of opposed inclination, making it possible to form guiding ramps for a long flow of the silicon down to the bottom of the lower plate, before its return into the crucible. FIGS. 12a and 12b represent a final variant in cylindrical form, having a flat surface bearing circular obstacles.

In all the cases, the geometry of the evaporator is thus chosen so as to obtain a large interface between the silicon it contains and the vapour of the chamber, for a time sufficient to obtain a chosen purification. To do this, the evaporator may finally comprise the following characteristics:
formation of a long flow or large surface area of storage of the silicon, by using several superposed levels, forming flat or inclined surfaces, optionally with obstacles, chicanes, pouring reservoirs, channels, etc., to slow down a flow or to spread the silicon. To do this, the solutions envisaged previously are based on horizontal plates allowing a large storage surface, or on inclined plates allowing a slow flow of the silicon from plate to plate;
thus, the evaporator comprises at least one plate that may contain a small thickness of silicon in comparison with the upper surface area of this amount of silicon, which is thus in the form of a film or fine layer of material;
the evaporator also envisages a final return of the silicon to the crucible, either by direct flow or by any indirect means.

Naturally, other embodiments of a purification device may be imagined, especially by differently combining the various components presented previously. Furthermore, it is possible to imagine any other mobility of an evaporator or of a pouring crucible, not necessarily in simple translation, even though this solution has the advantage of simplicity. Furthermore, any other device for periodically renewing a certain amount of silicon on an evaporator, by transferring silicon between a crucible and an evaporator, may be implemented.

The functioning of a silicon purification device as described previously will now be detailed. It allows the implementation of an advantageous purification process, illustrated schematically by FIGS. 13 and 14.

In a preliminary step E0, a certain amount of silicon is introduced into the purification device 20, via an introduction device 23. This silicon may be introduced in solid form, or liquid form, optionally already at high temperature. This introduction advantageously takes place in a crucible 2, which may remain hot to optimize the production efficiency of the device by avoiding temperature decreases and increases.

When this introduction of silicon is complete, the process comprises a step E1 that consists in bringing the device to high temperature, to obtain a bath 5 of molten silicon, which is maintained in this liquid state. The temperature of the silicon bath present in the crucible thus remains above the melting point of silicon (1420° C.) and advantageously above 1500° C. In parallel, the pressure in the chamber 21 of the device is greatly reduced, under a maximum functioning value. This maximum value of the vapour pressure is less than 1 pascal and advantageously less than or equal to 0.1 pascal.

When the preceding conditions are reached, the silicon purification step E2 is engaged, and especially its dephosphoration. This step consists of a repetition of phases of treating the silicon in the evaporator(s). At each treatment phase, all or part of the silicon introduced into the purification device is distributed over the plates of an evaporator. During this residence on the evaporator, the silicon becomes greatly purified, due to its large surface area with respect to the very low pressure vapour of the chamber 21 of the device and due to the high temperature of the liquid silicon on the evaporator, as has been explained previously.

Between each treatment phase, the purification process comprises a step E21 of total or partial renewal of the silicon present on the evaporator 10. This renewal is obtained by immersing one or more evaporators in the crucible containing the silicon bath, or by immersing one or more pouring crucibles, or by any other equivalent device that allows the transfer of at least part of the silicon from a storage bath to the evaporator. The immersion of a component into the silicon bath during this step has the advantage of inducing an additional stirring effect of the silicon bath, which is favourable to its treatment. As a variant, any other stirring device may be used, for example functioning by induction. This stirring increases the phenomenon of purification of the silicon present in the crucible.

After this immersion, or more generally after transferring the silicon onto the evaporator, a step E22 of evaporating the impurities from the silicon present on the evaporator is performed (the optional immersed component is raised out of the crucible). In the case of immersion of one or more evaporators, part of the liquid silicon remains on the plates 12 of the evaporator when it is raised. In the case of the immersion of a pouring spout, part of the silicon is raised in this pouring spout, and is gradually versed onto the plates of the evaporator. The rates of immersion and of withdrawal of the evaporator or of the pouring crucible of the silicon bath are such that they do not cause any projection of liquid silicon beyond the tools provided for recovering the liquid silicon. For this, these immersion and withdrawal rates are preferably between 0.5 mm/s and 10 cm/s and advantageously between 1 mm/s and 1 cm/s.

In the implementation example described with reference to FIGS. 1 and 2, the evaporator can move in vertical translation at a speed of 3 cm/s, and can remain in the top position for 30 seconds before a new immersion.

During this treatment phase, the purification process advantageously comprises another step E23 of heating the silicon present on the evaporator outside the crucible, by a heating device 14 at the top of the chamber mentioned previously. This heating advantageously makes it possible to maintain a temperature of the silicon on the evaporator of greater than 1500° C., or even higher, and thus makes it possible to accelerate the purification kinetics. The higher this temperature, the greater the purification kinetics.

Throughout this purification step E2, the heating of the crucible 2, and optionally of the evaporator, is regulated so as to keep the liquid silicon in the crucible 2 close to an average temperature that may be set, for example, at 1630° C., and in any case greater than or equal to 1420° C., the melting point of silicon.

The treatment time is predefined as a function of the desired result, especially of the desired dephosphoration. When this treatment is judged sufficient, the treatment phases described above are stopped, and the purification step E2 is terminated. In the case of a mobile evaporator or pouring crucible, this component is repositioned outside of the silicon bath.

When the purification step E2 is complete, the temperature of the silicon is lowered to a pouring temperature, for example of 1500° C., to engage a step E3 of output of the purified silicon from the chamber of the purification device. The silicon may, for example, be poured into an ingot mould. As a variant, this pouring may be performed inside the chamber.

FIG. 14 illustrates, for example, a particular embodiment of this silicon output step E3. This step is performed using a silicon purification device which comprises a dished part mounted on a tipping block, to take an inclined position which allows the purified liquid silicon to flow. This pouring may take place into an ingot mould 33.

As a variant, the solidification of the silicon may be performed directly in the crucible, in a controlled manner, for example using chamber heating devices, to control the silicon expansion phenomena.

This silicon purification process may be performed using a single chamber 21, such as those illustrated by FIGS. 1 to 7, or as a variant using several silicon baths each equipped with one or more evaporators, in different chambers or the same chamber, so as to perform the chain treatment in the various baths in series, as particularly represented by FIG. 13.

The principle described previously is applicable to any amount of silicon, which may range, for example, from 200 grams to 1.5 tons of silicon per crucible. It allows the production of a purified silicon whose phosphorus content may be very low, down to contents of less than or equal to 0.1 ppmw. Naturally, this process acts on several elements present in the silicon and also allows the silicon to be purified, besides phosphorus, of aluminium, calcium, zinc, tin, lead, bismuth, sodium, magnesium, manganese, potassium, arsenic, etc.

The adopted solution finally has the following advantages:
it is compatible with an industrial implementation, since it makes it possible to achieve a satisfactory rate for obtaining purified silicon at low cost. For example, a test of use of a purification device with an evaporator heated to about 1750° C. and with a 15 kg load of silicon heated to 1630° C. in the crucible, shows that a 5 hour treatment makes it possible to go from 15 ppmw to 0.3 ppmw of phosphorus;
it can function with any initial state of the silicon, solid or liquid, and with any type of silicon;
it makes it possible to achieve a silicon purification that is compatible with applications of photovoltaic type;
it makes it possible to purify phosphorus from silicon originating from old solar cells;
it remains compatible with other purification processes, and can be combined with these other processes;
it can even be used for the purification of any other liquid material, not necessarily silicon, by simply adapting the operating conditions (temperature, pressure) to a material under consideration.

1. A device for purifying a molten material such as silicon, comprising:
a chamber comprising a crucible for storing a molten material and a heating device for heating the molten material contained in the crucible, the chamber being equipped with a device for greatly lowering the pressure in the chamber,
at least one evaporator placed inside the chamber to receive part of the molten material, such that the molten material has a large interface with low-pressure vapour present in the chamber to promote and accelerate the purification of the molten material, and
at least one device for renewing or recirculating the molten material in the at least one evaporator.

2. The device according to claim 1, which comprises at least one heating device for heating the molten material contained in the at least one evaporator.

3. The device according to claim 1, which comprises a fixed pouring crucible positioned above the at least one evaporator, which is a fixed evaporator, allowing a flow of the molten material while purifying the molten material up to a recovery tank.

4. The device according to claim 1, which comprises at least one mobile component allowing several circulations of the molten material in the at least one evaporator.

5. The device according to claim 4, wherein the at least one crucible is located in a bottom part of the chamber, and the at least one evaporator is mobile between a top position out of the crucible and a bottom position in which the evaporator is at least partially placed in the crucible.

6. The device according to claim 4, which comprises at least one pouring crucible that is mobile between a top position outside the crucible, in which the at least one pouring crucible is capable of versing molten material onto the evaporator, and a bottom position, in which the at least one pouring crucible is at least partially placed in the crucible.

7. The device according to claim 5, wherein the mobile evaporator comprises an axle passing through the chamber via a leaktight aperture and a motor outside the chamber acting on the axle to actuate the mobile evaporator.

8. The device according to claim 1, wherein at least one of (i) a heating device for heating the molten material contained in the crucible and (ii) a heating device for heating the molten material contained in the at least one evaporator is of resistive or inductive type.

9. The device according to claim 1, which comprises a device for stirring the molten material present in the crucible.

10. The device according to claim 1, wherein the at least one evaporator comprises several at least partially superposed horizontal or inclined plates.

11. A process for purifying a molten material such as silicon placed in a purification device according to claim 1, comprising:
a step of heating and melting the molten material present in the crucible of the purification device and lowering the pressure in the chamber of the purification device,
a step of moving at least part of the molten material from the crucible to the at least one evaporator, and
a step of totally or partially renewing or recirculating the molten material present on the at least one evaporator.

12. The process according to claim 11, wherein the temperature of the molten material is maintained above or equal to 1500° C. and the pressure in the chamber of the purification device is lowered to a value of less than or equal to 1 Pascal.

13. The process according to claim 11, which comprises a step of purifying the molten material comprising a repetition of moving and then renewing an amount of molten material on the at least one evaporator using the molten material present in the crucible of the purification device.

14. The process according to claim 13, wherein the purification step comprises a step of totally or partially renewing the molten material present on the at least one evaporator by immersing the at least one evaporator in the crucible of the purification device or by immersing at least one pouring crucible in the crucible of the purification device followed by gradual pouring of its contents onto the at least one evaporator.

15. The process according to claim 14, wherein the step of purifying the molten material comprises a step of evaporating impurities from the molten material present on the at least one evaporator.

16. The process according to claim 13, wherein the rate of immersion and of withdrawal of the at least one evaporator or of the pouring crucible is between 0.5 mm/s and 10 cm/s.

17. The process according to claim 13, which comprises a step of heating the molten material present on the evaporator outside the crucible.

18. The device according to claim 2, which comprises a fixed pouring crucible positioned above at least one fixed evaporator allowing a flow of the molten material while purifying the molten material up to a recovery tank.

19. The device according to claim 2, which comprises at least one mobile component allowing several circulations of the molten material in the at least one evaporator.

20. The device according to claim 6, wherein the mobile pouring crucible comprises an axle passing through the chamber via a leaktight aperture and a motor outside the chamber acting on the axle to actuate the mobile pouring crucible.
